(19) United States
(12) Patent Application Publication
(10) Pub. No.: US 2026/0094311 A1
(43) Pub. Date: Apr. 2, 2026

(54) SYSTEM AND METHOD FOR GENERATING IMAGES TO ILLUSTRATE NARRATIVES

(71) Applicant: Toyota Research Institute, Inc., Los Altos, CA (US)

(72) Inventors: Scott Carter, San Jose, CA (US); Monica P. Van, San Leandro, CA (US); Katharine A. Sieck, Santa Monica, CA (US); Eldy Deines, Crested Butte, CO (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/903,266

(22) Filed: Oct. 1, 2024

(51) Int. Cl. G06T 11/00; G06F 3/0483; G06F 3/14

(52) U.S. Cl. CPC G06T 11/00; G06F 3/0483; G06F 3/14

(57) ABSTRACT

Systems and methods for illustrating narratives are described. In one example, a system includes a processor and a memory that is in communication with the processor. The memory includes instructions that, when executed by the processor, cause the processor to generate an avatar using a generative artificial intelligence (AI) model and user input, determine, using the generative AI model and based on a story from the user that involves the avatar as a character in the story, a point-of-view of the avatar, and generate, using the generative AI model, at least one output image for a book based on the story and the point-of-view of the avatar.

### TECHNICAL FIELD

The subject matter described herein relates, in general, to systems and methods for generating images to illustrate narratives.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Through the written or spoken word, humans have told stories to each other across a wide array of subjects, from fictional to biographical. While written and spoken media can be generated rapidly without the use of specialized skills, creating aesthetically pleasing visual content can be extremely time-consuming, costly, and generally requires expert skills.

### SUMMARY

This section generally summarizes the disclosure and is not a comprehensive explanation of its full scope or all its features.

In one embodiment, a system includes a processor and a memory that is in communication with the processor. The memory includes instructions that, when executed by the processor, causes the processor to (1) generate an avatar using a generative artificial intelligence (AI) model and user input, (2) determine, using the generative AI model and based on a story from the user that involves the avatar as a character in the story, a point-of-view of the avatar, and (3) generate, using the generative AI model, at least one output image for a book based on the story and the point-of-view of the avatar.

In another embodiment, a method includes the steps of (1) generating an avatar using a generative AI model and user input, (2) determining, using the generative AI model and based on a story from the user that involves the avatar as a character in the story, a point-of-view of the avatar, and (3) generating, using the generative AI model, at least one output image for a book based on the story and the point-of-view of the avatar.

In yet another embodiment, a non-transitory computer-readable medium includes instructions that, when executed by a processor, causes the processor to (1) generate an avatar using a generative artificial intelligence (AI) model and user input, (2) determine, using the generative AI model and based on a story from the user that involves the avatar as a character in the story, a point-of-view of the avatar, and (3) generate, using the generative AI model, at least one output image for a book based on the story and the point-of-view of the avatar.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one example of a narrative illustration system being used to generate images to illustrate narratives based on information provided by a user.

FIG. 2 illustrates a more detailed view of one example of the narrative illustration system of FIG. 1.

FIGS. 3A-3C illustrate a method for generating images that illustrate narratives.

### DETAILED DESCRIPTION

Described herein are systems and methods for generating images that can be utilized to illustrate narratives, such as narratives that form stories for books. As mentioned in the background section, creating images to match narratives can be time-consuming, costly, and require highly specialized skills. The systems and methods described herein utilize one or more generative artificial intelligence (AI) models to assist with creating images to match narratives.

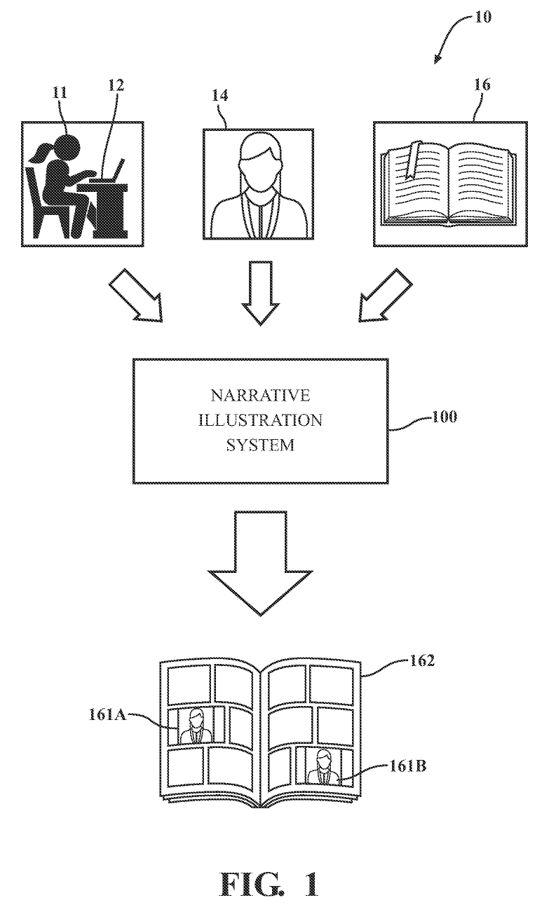

In order to better understand the systems and methods described herein, reference is made to FIG. 1, which illustrates an example scenario 10 wherein a user 11 can utilize a narrative illustration system 100 to generate image(s) 161A and 161B for illustrating a book(s) 162, which can take one of a number of different forms and can be utilized to create other types of media, such as printable books, actual physical books, comic books, graphic novels, audiobooks, and the like. It should be understood that the scenario 10 is merely to provide a broad overview of some of the features of the systems and methods that will be described in more detail later in this description.

Broadly, the user 11 can provide information to the narrative illustration system 100 regarding an avatar that is a character in a particular story 16. This input information can include one or more input image(s) 14, which may be images illustrating the avatar, such as photographs, illustrations, and the like. Additionally or alternatively, the input information can also include text input 12 wherein the user 11 provides text input 12 regarding what the avatar should look like. For example, the avatar could be described by the user 11 as “an old man carrying a staff with a long white beard, a gray robe, and a gray hat.”

As will be explained in greater detail later in this description, once received, the narrative illustration system 100 can generate an appropriate avatar using one or more generative AI models. As mentioned before, this avatar is essentially a character in the story 16. The generation of the appropriate avatar essentially allows the user 11 to input themselves or someone else into the story 16 so as to personalize the story 16. For example, if the user 11 works at a large corporation and would like to generate a book with herself as a character, the narrative illustration system 100 can generate an appropriate avatar based on the input image(s) 14 provided by the user 11. Once the avatar is generated, the story 16 is inputted into the narrative illustration system 100, wherein the narrative illustration system 100, using one or more generative AI models can determine the point of view of the avatar within the story. For example, the avatar within the story 16 may be a first-person character, third-person character, or even some combination of the two, wherein the avatar may be a first-person character in certain parts of the story but a third-person character in other parts of the story.

Once the story 16, which may be a chapter of a book, is inputted into the narrative illustration system 100, the narrative illustration system 100 generates image(s) 161A-161B that consider not only the story 16 but also how the avatar fits within the story 16, such as if the avatar is a first-person and/or third person character. From there, the narrative illustration system 100 may generate a book(s) 162 that complements the text of the story 16 with appropriate image(s) 161A-161B. From there, the book(s) 162 can be utilized to generate a number of different types of media, such as printable books, actual books, audiobooks, etc.

As such, the example of the scenario 10 allows the user 11 to generate a book with appropriate images to better describe the story 16. The narrative illustration system 100 essentially allows the user 11 to create highly customized books to tell stories from a unique point of view that is efficient, low cost, and does not require a unique artistic skill set.

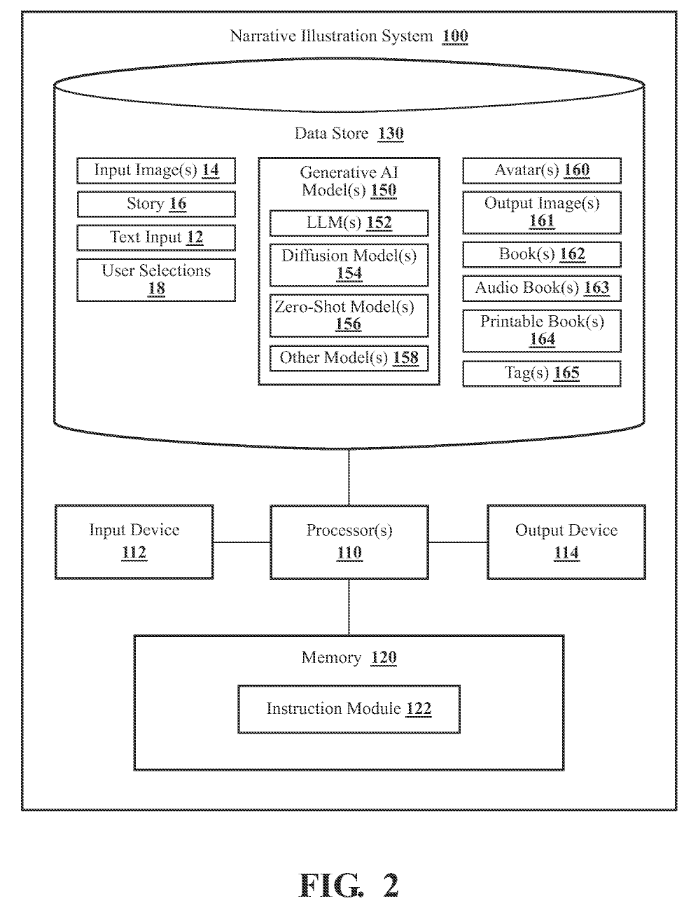

Referring to FIG. 2, illustrated is a more detailed view of the narrative illustration system 100. It should be understood that the narrative illustration system 100 is just one example that the narrative illustration system 100 may take. As such, the narrative illustration system 100 may have more, fewer, or even different components than those illustrated in FIG. 2.

Here, in this example, the narrative illustration system 100 includes one or more processor(s) 110. Accordingly, the processor(s) 110 may be a part of the narrative illustration system 100, or the narrative illustration system 100 may access the processor(s) 110 through a data bus or another communication path. In one or more embodiments, the processor(s) 110 is an application-specific integrated circuit that is configured to implement functions associated with an instruction module 122. In general, the processor(s) 110 is an electronic processor, such as a microprocessor, which is capable of performing various functions as described herein.

The narrative illustration system 100 may also include an input device 112 and/or an output device 114 that is in communication with the processor(s) 110. The input device 112 may be any type of device that can provide input to the processor(s) 110. As such, the input device 112 could be a keyboard, mouse, microphone, camera, and the like. Further, it should also be understood that the input device 112 could act as a conduit to communicate with other devices (i.e., network access device), either wired or wirelessly. Similarly, the output device 114 can be any device that is capable of outputting information generated by the narrative illustration system 100. As such, the output device 114 could be a monitor, printer, virtual reality headset, or speaker or could act as a conduit to communicate with other devices (i.e., network access device), either wired or wirelessly.

In one example, the narrative illustration system 100 includes a memory 120 that stores instruction module 122. The memory 120 may be a random-access memory (RAM), read-only memory (ROM), a hard disk drive, a flash memory, or other suitable memory for storing the instruction module 122. The instruction module 122 is, for example, computer-readable instructions that, when executed by the processor(s) 110 cause the processor(s) 110 to perform the various functions disclosed herein.

Furthermore, in one example, the narrative illustration system 100 includes a data store 130. The data store 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store 130 stores data used by the instruction module 122 in executing various functions.

In this example, the data store 130 may include any type of electronic information used in or generated by the processor(s) 110 when executing any of the methodologies described herein. In this example, the data store 130 may include information that was inputted by the user 11, such as text input 12, the input image(s) 14, the story 16, and/or user selections 18. This may be provided to the data store 130 using the input device 112. For example, the text input 12 provided by the user could be provided by a keyboard, microphone, or other input device. The input image(s) 14, as previously described, may be images of one or more characters that will be utilized to generate the avatar(s) 160. The input image(s) 14 may be a representation of a visual object, such as a person or character, in a format that can be processed by the processor(s) 110. The story 16, as mentioned previously, can be in a digital text format and may contain multiple narratives, chapters, sections/subsections, paragraphs, and the like.

The data store 130 may also contain one or more generative AI model(s) 150. The generative AI model(s) 150 used by the narrative illustration system 100 may be modular in nature and can change from application to application or when there are technological advances. For example, when generative AI models become more advanced, the generative AI model(s) 150 stored within the data store 130 can be replaced with more advanced models. As such, it should be understood that the one or more generative AI model(s) 150 can include more, fewer, or different generative AI models mentioned.

In one example, the generative AI model(s) 150 may include one or more large language models (“LLMs”) 152, diffusion model(s) 154, zero-shot model(s) 156, and/or other model(s) 158. As mentioned before, the generative AI model(s) 150 may vary considerably. In one example, the LLM(s) 152 and/or the diffusion model(s) 154 may be fine-tuned using a Low-Rank Adaptation (“LoRA”) methodology. The zero-shot model(s) 156 may be utilized to maintain character consistency throughout the use of one or more images injected at inference time. In addition, the narrative illustration system 100 can also rely on prompt engineering to influence generated images. For example, foundation models may be used directly and require a detailed preamble prompt fed to the models to maintain character consistency. Again, it should be understood that the generative AI model(s) 150 can vary considerably than described above.

The data store 130 can also store information that was created by the narrative illustration system 100. As explained before, this can include the avatar(s) 160, output image(s) 161, which may be illustrations for narratives, book(s) 162, audiobook(s) 163, and printable book(s) 164. In addition, the data store 130 may also store one or more tag(s) 165 that can be utilized to organize and categorize the book(s) 162, the audiobook(s) 163, and/or the printable book(s) 164.

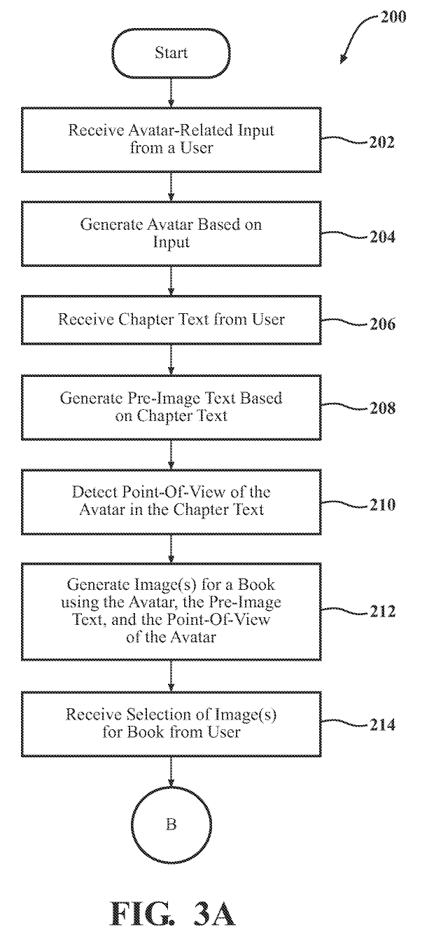

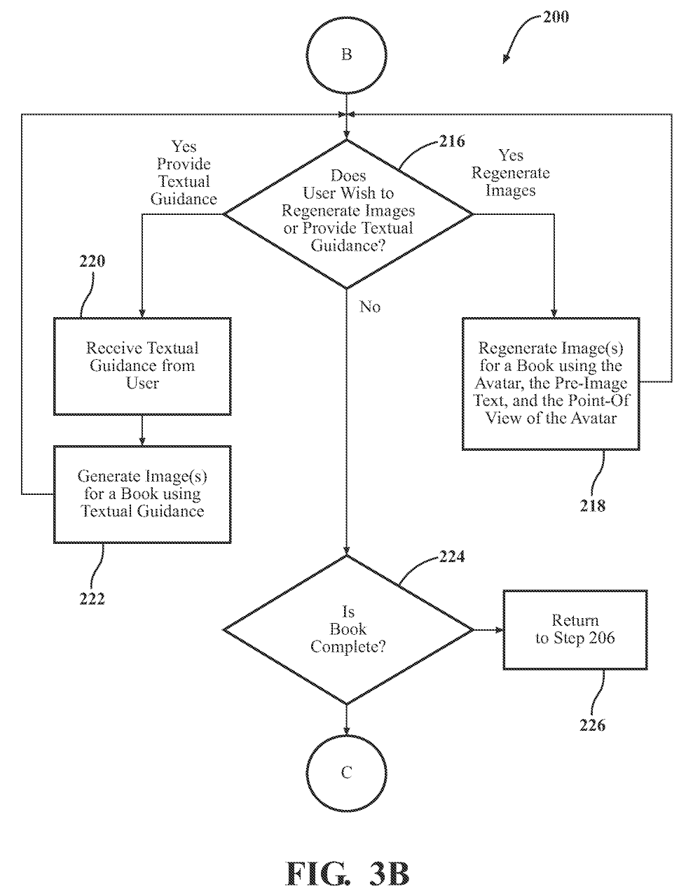

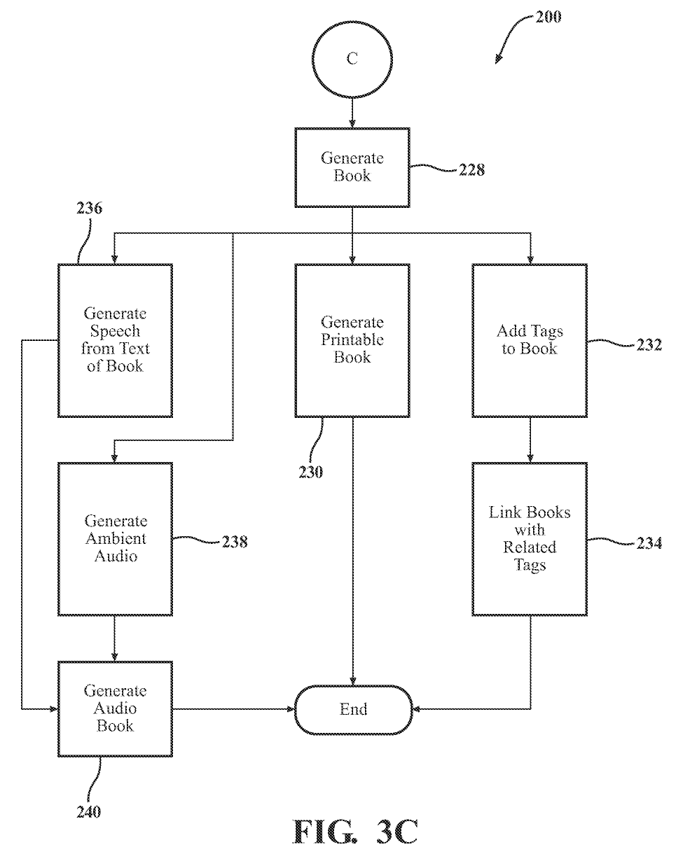

As mentioned before, the instruction module 122 contains instructions that cause the processor(s) 110 to perform any of the methodologies described herein. With reference to FIGS. 3A-3C, illustrated is a method 200 for illustrating narratives, such as stories. The method 820000 will be described from the viewpoint of the narrative illustration system 100 in FIG. 2. However, it should be understood that this is just one example of implementing the method 200. While the method 200 is discussed in combination with the narrative illustration system 100, it should be appreciated that the method 200 is not limited to being implemented within the narrative illustration system 100, but is instead one example of a system that may implement the method 200. As such, the method 200 may be embodied within the instruction module 122 as processor-executable instructions that, when executed by the processor(s) 110, cause the processor(s) 110 to perform the method 200.

In step 202, the instruction module 122 includes instructions that, when executed by the processor(s) 110, cause the processor(s) 110 to receive avatar-related input from a user, such as the user 11 of FIG. 1. As such, it should be understood that the avatar related input can take one of a number of different forms. For example, the avatar input could be the text input 12 provided by the user by utilizing the input device 112, such as a keyboard, microphone, and the like. For example, the user 11, as previously mentioned, could provide a textual description of the avatar. Additionally or alternatively, the avatar related input could also include one or more input image(s) 14.

In step 204, the instruction module 122 includes instructions that, when executed by the processor(s) 110, cause the processor(s) 110 to generate one or more avatar(s) 160 based on the avatar-related input mentioned in the paragraph above. Additionally or alternatively, a set of pre-trained character LoRAs may also be provided, as well as a set of image portraits that can be used as the base image for zero-shot models.

Whatever form the avatar-related input takes, the one or more generative AI model(s) 150 receive the avatar related input and use this information to generate the avatar(s) 160 that generally match the deployment style provided by the avatar-related input. The deployment style may be the style in which the user 11 wants the avatar(s) 160 and/or the output image(s) 161 to take. More specifically, the deployment style can indicate the overall look for the avatar(s) 160 and/or the output image(s) 161. For example, the deployment style might be highly colorful with simple shapes, more suitable for younger children, but could also be much more graphical and be more suitable for older children and adults. Further still, the artistic expression in which the avatar(s) 160 and/or the output image(s) 161 are generated can also be considered part of the deployment style. For example, this can include classic pencil and ink, dynamic and expressive to convey actions and emotions, realistic and detailed that emphasizes intricate line work, cartoon and caricature that generally include vibrant colors and simpler lines, mixed media and experimental the combined traditional drawing techniques with digital art, etc. Additionally, mimicking the styles of other artists can also be considered part of the deployment style, such as Gustave Doré, Vincent Van Gogh, Leonardo da Vinci, Albrecht Dürer, Michelangelo, Hieronymus Bosch, and the like.

As mentioned before, the avatar(s) 160 may be one or more characters in a story of the book. For example, the zero-shot model(s) 156 may be utilized to generate images that act as the avatar(s) 160. As a variant, instead of being images, the avatar(s) 160 could also be a 3D model of the avatar(s) 160. As such, the narrative illustration system 100 can leverage augmented reality technology to overlay the 3D avatar on top of printed media.

In one example, the processor(s) 110 may create multiple avatars of the same character. When this occurs, the multiple avatars will be displayed to the user 11 utilizing the output device 114. The user 11 can then select the avatar that they believe best fits the character utilizing the input device 112. Further still, the user 11 may also be able to request that the avatar(s) 160 be regenerated and/or provide additional information if the results are not acceptable to the user 11.

Once the avatar(s) 160 are created, the method 200 proceeds to step 206, wherein the instruction module 122 causes the processor(s) 110 to receive chapter text, which may be in the form of the story 16 from the user 11. In one example, the story 16 may include multiple chapters in the form of digital text that can be processed by the processor(s) 110. In some examples, the narrative illustration system 100 may utilize the LLM(s) 152 to create prompts for each chapter using a system that can be tailored. Moreover, prompts provided to the user 11 could include things such as requests regarding visual details, time of day, year, setting, location, and other details regarding the story 16.

Once the chapter text and/or additional information from the user 11 (such as responses to prompts) is received, the method 200 proceeds to step 208, wherein the instruction module 122 causes the processor(s) 110 to generate pre-image text based on the received chapter text and/or additional information from the user 11. In one example, this may occur by having the processor(s) 110 utilize the one or more generative AI model(s) 150, such as the LLM(s) 152 to match the deployment style. More simply, the LLM(s) 152 modify the chapter text and/or additional information to match the deployment style of the avatar(s) 160.

The pre-image text may not be the same text that will be utilized in the book(s) 162 generated by the narrative illustration system. Moreover, the pre-image text is to provide a more useful input to the generative AI model(s) 150 so that more satisfactory output image(s) 161 are generated that generally match the deployment style of the avatar(s) 160. For example, in cases where the chapter text is in a language that is not compatible with the particular generative AI model, the modification of the chapter text to the pre-image text may involve translating the chapter text to a language that is compatible with the particular generative AI model. The pre-image text can also include other additional information that is detected or otherwise determined by the LLM(s) 152, such as the gender, race, ethnicity, or other traits of the avatar(s) 160.

In step 210, the instruction module 122 causes the processor(s) 110 to determine whether the chapter text and/or pre-image text is written in the first-person or third-person perspective. This can be done by utilizing the LLM(s) 152 to analyze the chapter text and/or the pre-image text to determine the point of view of the avatar(s) 160. This point of view information can form part of the pre-image text previously mentioned or can be stored separately.

In step 212, the instruction module 122 includes instructions that, when executed by the processor(s) 110, cause the processor(s) 110 to generate the output image(s) 161 using the avatar(s) 160, the pre-image text, and the detected point of view of the avatar(s) 160. This can be achieved by having the processor(s) 110 utilize one or more of the generative AI model(s) 150, such as the zero-shot model(s) 156, to generate images related to the chapter text previously provided.

In some cases, the processor(s) 110 will generate multiple output image(s) 161 and allow the user 11 to select which images they would like to form part of the book(s) 162 using the input device 112. For example, the multiple output image(s) 161 could be displayed on the output device 114, and the user 11 could utilize a mouse or other input device to select which images of the multiple output image(s) 161 they want to utilize.

In some cases, the user 11 may not be satisfied with the output image(s) 161 generated by the generative AI model(s) 150. As such, the method 200 may also allow for the generation of additional output images. For example, in step 216, the instruction module 122 includes instructions that, when executed by the processor(s) 110, cause the processor(s) 110 to receive an input from the user 11 via the input device 112, indicating if the output image(s) 161 are either acceptable to the user 11 or should be regenerated and/or generated using textual guidance.

For example, if the user 11 selects regeneration, the method will proceed to step 218, wherein the instruction module 122 cause the processor(s) 110 to regenerate the output image(s) 161 utilizing the same information in step 212, namely, the avatar(s) 160, the pre-image text, and the detected point of views of the avatar(s) 160. If the user 11 selects providing textual guidance, as shown in step 214, the method 200 will proceed to step 220, wherein the user 11 will provide textual guidance to the input device 112, which will be utilized by the generative AI model(s) 150 to generate the output image(s) 161, as shown in step 222. After either steps 218 or 222 are completed, the method 200 returns to step 216, as shown in step 226, wherein the user 11 can review the newly generated output image(s) 161 to determine if they are acceptable.

If the output image(s) 161 is acceptable to the user 11, the method proceeds to step 224, wherein instruction module 122 causes the processor(s) 110 to query the user 11 via the output device 114 whether the book is completed. Essentially, the user 11 is being asked if there are additional chapters or chapter text that need to be entered so they can be illustrated. The user 11 can answer this query utilizing the input device 112. If not complete, the method 200 returns to step 206, wherein the user can input text from an additional chapter of the book.

However, if the book is complete, the method 200 would then proceed to step 228, wherein the instruction module 122 causes the processor(s) 110 to generate the book(s) 162. It should be understood that the book(s) 162 may not be traditional printed books, but may be a collection of one or more electronic files that contain information regarding the story 16 and the output image(s) 161 that illustrate the story and the various chapters that comprise the story 16.

After the book(s) 162 is generated, the method 200 may stop but can also continue to generate other media based on the book(s) 162. For example, in step 230, the instruction module 122 causes the processor(s) 110 to generate printable book(s) 164 that may be files, such as Adobe Portable Document Format, which can be viewed by others or be utilized to print traditional printed books.

In another example, the instruction module 122 causes the processor(s) 110 to add one or more tag(s) 165 to the book(s) 162, as illustrated in step 232. The tag(s) 165 may be electronic identifiers that identify the subject matter, author, genre, setting, etc. From there, the instruction module 122 may cause the processor(s) 110 to link the book(s) 162 that have related tags, as shown in step 234. As such, related books can easily be discovered.

As an alternative, the narrative illustration system 100 can also generate audiobooks. For example, in step 236, the instruction module 122 may cause the processors to generate speech from the text of the book(s) 162. This may be achieved by utilizing one or more generative AI model(s) 150 or discrete algorithms that convert text to speech. Additionally, as shown in step 238, the instruction module 122 may cause the processor(s) 110 to generate ambient audio for the audiobook. For example, the processor(s) 110 could utilize one or more generative AI model(s) 150 to generate ambient audio representations for each chapter. After that, in step 240, the instruction module 122 could cause the processor to utilize speech generated in 236 and ambient audio generated in step 238 to generate the audiobook(s) 163.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user’s computer, partly on the user’s computer, as a stand-alone software package, and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, as indicating the scope hereof.

What is claimed is:

1. A system comprising:
a processor;
a memory in communication with the processor, the memory including instructions that, when executed by the processor, causes the processor:
generate, based on an input provided by a user, an avatar using a generative artificial intelligence (AI) model, wherein the input comprises at least one of an input image and a textual description;
determine, using the generative AI model and based on a story from the user that involves the avatar as a character in the story, a point-of-view of the avatar, wherein the point-of-view of the avatar is one of a first-person character and a third-person character of the story; and
generate, using the generative AI model, at least one output image for a book based on the story and the point-of-view of the avatar, wherein the at least one output image is from the point-of-view of the avatar.

2. The system of claim 1, wherein the generative AI model at least includes at least one of:
a diffusion model trained using a Low-Rank Adaptation training technique;
a prompt-engineered foundation model; and
a zero-shot model.

3. The system of claim 1, wherein the memory further includes instructions that, when executed by the processor, causes the processor to:
generate, based on the input image provided by the user, a plurality of avatars using the generative AI model; and
receive, from the user, a selection of one of the plurality of avatars.

4. The system of claim 1, wherein the memory further includes instructions that, when executed by the processor, causes the processor to provide a story prompt to the user, wherein the story prompt requests additional information regarding the story from the user, the story prompt being generated by the generative AI model.

5. The system of claim 1, wherein the memory further includes instructions that, when executed by the processor, causes the processor to:
modify, using the generative AI model, text of the story to generate pre-image text; and
generate, using the generative AI model the at least one output image for the book using the pre-image text.

6. The system of claim 1, wherein the memory includes further instructions that, when executed by the processor, causes the processor to:
display the at least one output image, wherein the at least one output image includes multiple output images; and
receive a selection from the user of at least one of the multiple output images for the book.

7. The system of claim 6, wherein the memory further includes instructions that, when executed by the processor, causes the processor to, in response to receiving a regeneration command from the user, regenerate, using the generative AI model, regenerated multiple output images for the book based on the story and the point-of-view of the avatar, wherein the regenerated multiple output images are from the point-of-view of the avatar.

8. The system of claim 6, wherein the memory further includes instructions that, when executed by the processor, causes the processor to, in response to receiving a textual description from the user, regenerate, using the generative AI model and the textual description, regenerated multiple output images for the book.

9. The system of claim 1, wherein the memory further includes instructions that, when executed by the processor, causes the processor to perform at least one of:
generate a printable book using the story and the at least one output image; and
generate an audiobook using the story and the at least one output image.

10. A method comprising:
generating, based on an input provided by a user, an avatar using a generative artificial intelligence (AI) model, wherein the input comprises at least one of an input image and a textual description;
determining, using the generative AI model and based on a story from the user that involves the avatar as a character in the story, a point-of-view of the avatar, wherein the point-of-view of the avatar is one of a first-person character and a third-person character of the story; and
generating, using the generative AI model, at least one output image for a book based on the story and the point-of-view of the avatar, wherein the at least one output image is from the point-of-view of the avatar.

11. The method of claim 10, wherein the generative AI model at least includes at least one of:
a diffusion model trained using a Low-Rank Adaptation training technique;
a prompt-engineered foundation model; and
a zero-shot model.

12. The method of claim 10, further comprising:
generating, based on the input image provided by the user, a plurality of avatars using the generative AI model; and
receiving, from the user, a selection of one of the plurality of avatars.

13. The method of claim 10, further comprising providing a story prompt to the user, wherein the story prompt requests additional information regarding the story from the user, the story prompt being generated by the generative AI model.

14. The method of claim 10, further comprising:
modifying, using the generative AI model, text of the story to generate pre-image text; and
generating, using the generative AI model the at least one output image for the book using the pre-image text.

15. The method of claim 10, further comprising:
displaying the at least one output image, wherein the at least one output image includes multiple output images; and
receiving a selection from the user of at least one of the multiple output images for the book.

16. The method of claim 15, further comprising, in response to receiving a regeneration command from the user, regenerating, using the generative AI model, regenerated multiple output images for the book based on the story and the point-of-view of the avatar, wherein the regenerated multiple output images are from the point-of-view of the avatar.

17. The method of claim 15, further comprising, in response to receiving a textual description from the user, regenerating, using the generative AI model and the textual description, regenerated multiple output images for the book.

18. The method of claim 10, further comprising at least one of:
generating a printable book using the story and the at least one output image; and
generating an audiobook using the story and the at least one output image.

19. A non-transitory computer-readable medium storing instructions that, when executed by a processor, causes the processor to:
generate, based on an input provided by a user, an avatar using a generative artificial intelligence (AI) model, wherein the input comprises at least one of an input image and a textual description;
determine, using the generative AI model and based on a story from the user that involves the avatar as a character in the story, a point-of-view of the avatar, wherein the point-of-view of the avatar is one of a first-person character and a third-person character of the story; and
generate, using the generative AI model, at least one output image for a book based on the story and the point-of-view of the avatar, wherein the at least one output image is from the point-of-view of the avatar.

20. The non-transitory computer-readable medium of claim 19, wherein the generative AI model at least includes at least one of:
a diffusion model trained using a Low-Rank Adaptation training technique;
a prompt-engineered foundation model; and
a zero-shot model.
